(19) United States
(12) Patent Application Publication
(10) Pub. No.: US 2022/0060215 A1
(43) Pub. Date: Feb. 24, 2022

(54) TERMINAL APPARATUS AND BASE STATION APPARATUS

(71) Applicants: SHARP KABUSHIKI KAISHA, Sakai City, Osaka (JP); FG Innovation Company Limited, Tuen Mun (HK)

(72) Inventors: OSAMU NAKAMURA, Sakai City, Osaka (JP); YASUHIRO HAMAGUCHI, Sakai City, Osaka (JP)

(21) Appl. No.: 17/416,694

(22) PCT Filed: Dec. 23, 2019
(86) PCT No.: PCT/JP2019/050424

§ 371 Date: Jun. 21, 2021

(30) Foreign Application Priority Data
Dec. 28, 2018 (JP) 2018-247862

(51) Int. Cl. H04B 1/713; H04L 5/00; H04W 72/04; H04L 1/08

(52) U.S. Cl. CPC H04B 1/713; H04L 5/0012; H04L 1/08; H04W 72/0413; H04W 72/0446

(57) ABSTRACT

Efficient frequency hopping is performed in a case that repeated transmission is enabled in a slot. In a case that a configuration related to inter-slot frequency hopping is configured using RRC signaling, and a higher layer parameter related to a plurality of repeated transmissions in one slot is configured, frequency hopping is applied based on the current number of transmissions of transport blocks. On the other hand, in a case that the configuration related to the inter-slot frequency hopping is configured using the RRC signaling, and the higher layer parameter related to a plurality of repeated transmissions in one slot is not configured, frequency hopping is applied based on a current slot number.

### TECHNICAL FIELD

The present invention relates to a terminal apparatus and a base station apparatus. This application claims priority based on JP 2018-247862 filed on Dec. 28, 2018, the contents of which are incorporated herein by reference.

### BACKGROUND ART

In a Long Term Evolution (LTE) communication system specified by the Third Generation Partnership Project (3GPP), dynamic scheduling in which a base station apparatus notifies a terminal apparatus of Downlink Control Information (grant) (DCI) and data transmission is performed using the notified DCI has been specified. In the dynamic scheduling, transmission is performed once in a case that one piece of DCI is received. On the other hand, Semi-Persistent Scheduling (SPS) in which radio resources are periodically allocated is specified in addition to the dynamic scheduling. In the SPS, radio resources are periodically allocated even in a case that one piece of DCI is received, and it is thus possible to perform data transmission a plurality of times.

Currently, the 3GPP has been standardizing a fifth generation mobile communication (New Radio, or NR) using, as use cases, enhanced Mobile Broad Band. (eMBB), Ultra-Reliable and Low Latency Communications (URLLC), and massive Machine-Type Communications (mMTC). In NR Rel-15, Configured scheduling (CS) achieved by extending SPS in the LTE has been specified. In CS, it is possible to perform transmission with a slot repeated and thereby to improve transmission reliability.

The 3GPP has been working for standardization in Release 16 in order to achieve further high reliability (a packet reception success rate of 99.9999%) and a low delay property (a delay of 0.5 ms to 1 ms), (NPLs 1 and 2).

### CITATION LIST

### Non Patent Literature

NPL 1: Huawei, HiSilicon, Nokia, Nokia Shanghai Bell, “SID on Physical Layer Enhancements for NR URLLC”, RP-181477.

NPL 2: Huawei, HiSilicon, “Enhanced UL configured grant transmissions”, R1-1808100.

### SUMMARY OF INVENTION

### Technical Problem

In Rel-16, reliability and low latency are intended to be improved, and repeated transmission of a data signal (PUSCH) in one slot is discussed. On the other hand, an application of frequency hopping is specified in Rel. 15. However, frequency hopping at the time of repetition of the PUSCH in one slot is not discussed therein.

An aspect of the present invention has been made in view of such circumstances, and an object thereof is to provide an efficient application method of frequency hopping in PUSCH transmission performed a plurality of times in one slot.

### Solution to Problem

To address the above-mentioned drawbacks, a base station apparatus, a terminal apparatus, and a communication method according to the present invention are configured as follows.

(1) An aspect of the present invention provides a terminal apparatus for communicating with a base station apparatus, the terminal apparatus including a higher layer processing unit configured to configure a higher layer parameter related to frequency hopping and a higher layer parameter related to transmission of a plurality of transport blocks in a single slot, and a transmitter configured to perform transmission based on configurations configured by the higher layer processing unit, in which in a case that a configuration related to inter-slot frequency hopping is configured as the higher layer parameter related to the frequency hopping, and the higher layer parameter related to the transmission of the plurality of transport blocks in the single slot is configured, the transmitter applies the frequency hopping based on the current number of transmissions of transport blocks of the plurality of transport blocks.

(2) In an aspect of the present invention, the plurality of transport blocks may be generated from an identical information bit sequence with a different redundancy version.

(3) In an aspect of the present invention, the transmitter may apply the frequency hopping based on the current number of transmissions of the transport blocks and a current slot number in a radio frame.

(4) An aspect of the present invention provides a base station apparatus for communicating with a terminal apparatus, the base station apparatus including a higher layer processing unit configured to configure a higher layer parameter related to frequency hopping and a higher layer parameter related to transmission of a plurality of transport blocks in a single slot, and a receiver configured to receive a signal transmitted by the terminal apparatus based on configurations configured by the higher layer processing unit, in which in a case that a configuration related to inter-slot frequency hopping is configured as the higher layer parameter related to the frequency hopping, and the higher layer parameter related to the transmission of the plurality of transport blocks in the single slot is configured, the receiver performs reception assuming that the frequency hopping is applied based on the current number of transmissions of transport blocks of the plurality of transport blocks in the terminal apparatus.

(5) In an aspect of the present invention, the plurality of transport blocks may be generated from an identical information bit sequence with a different redundancy version.

(6) In an aspect of the present invention, the receiver may apply the frequency hopping based on the current number of transmissions of the transport blocks and a current slot number in a radio frame.

### Advantageous Effects of Invention

According to one or a plurality of aspects of the present invention, a base station apparatus and a terminal apparatus can efficiently apply frequency hopping in PUSCH transmission performed a plurality of times in one slot.

### BRIEF DESCRIPTION OF DRAWINGS

FIG. 1 is a diagram illustrating a configuration example of a communication system 1 according to the present embodiment.

FIG. 2 is a diagram illustrating a configuration example of a base station apparatus according to the present embodiment.

FIG. 3 is a diagram illustrating a configuration example of a terminal apparatus according to the present embodiment.

FIG. 4 is a diagram illustrating transmission of a plurality of transport blocks in one slot according to the present embodiment.

FIG. 5 is a diagram illustrating an example of a slot structure in a case that transmission of a plurality of blocks in one slot is performed and in a case that intra-slot frequency hopping is configured, according to the present embodiment.

FIG. 6 is a diagram illustrating an example of a slot structure in the case that transmission of the plurality of transport blocks in one slot is performed and in a case that inter-slot frequency hopping is configured, according to the present embodiment.

FIG. 7 is a diagram illustrating another example of a slot structure in the case that transmission of the plurality of transport blocks in one slot is performed and in the case that the inter-slot frequency hopping is configured, according to the present embodiment.

FIG. 8 is a diagram illustrating another example of a slot structure in the case that transmission of the plurality of transport blocks in one slot is performed and in the case that the intra-slot frequency hopping is configured, according to the present embodiment.

### DESCRIPTION OF EMBODIMENTS

A communication system according to the present embodiment includes a base station apparatus (a cell, a small cell, a serving cell, a component carrier, an eNodeB, a Home eNodeB, and a gNodeB) and a terminal apparatus (a terminal, a mobile terminal, and User Equipment (UE)). In the communication system, in a case of a downlink, the base station apparatus serves as a transmitting apparatus (a transmission point, a transmit antenna group, a transmit antenna port group, or a Tx/Rx Point (TRP)), and the terminal apparatus serves as a receiving apparatus (a reception point, a reception terminal, a receive antenna group, or a receive antenna port group). In a case of an uplink, the base station apparatus serves as the receiving apparatus, and the terminal apparatus serves as the transmitting apparatus. The communication system is also applicable to Device-to-Device or sidelink (D2D) communication. In this case, the terminal apparatus serves as both the transmitting apparatus and the receiving apparatus.

The communication system is not limited to one that is limited to data communication between the terminal apparatus and the base station apparatus with human intervention. In other words, the communication system is also applicable to a form of data communication requiring no human intervention, such as Machine Type Communication (MTC), Machine-to-Machine (M2M) Communication, communication for Internet of Things (IoT), or Narrow Band-IoT (NB-IoT) (hereinafter referred to as (MTC). In this case, the terminal apparatus serves as an MTC terminal. The communication system can use, in the uplink and the downlink, a multi-carrier transmission scheme, such as a Cyclic Prefix-Orthogonal Frequency Division Multiplexing (CP-OFDM). The communication system uses a transmission scheme such as Discrete Fourier Transform Spread-Orthogonal Frequency Division Multiplexing (DFTS-OFDM or also referred to as SC-FDMA) applying Transform preceding, that is, applying DFT in a case that a higher layer parameter related to Transform precoder is configured in the uplink. Although the following describes a case of using an OFDM transmission scheme in the uplink and the downlink, the transmission scheme is not limited to this and another transmission scheme may be applicable.

The base station apparatus and the terminal apparatus according to the present embodiment can communicate in a frequency band for which an approval of use (license) has been obtained from a country or region where a radio operator provides services, that is, a so-called licensed band, and/or in a frequency band for which no approval (license) from the country or region is required, that is, a so-called unlicensed band.

According to the present embodiment, “X/Y” includes the meaning of “X or Y”. According to the present embodiment, “X/Y” includes the meaning of “X and Y”. According to the present embodiment, “X/Y” includes the meaning of “X and/or Y”.

### First Embodiment

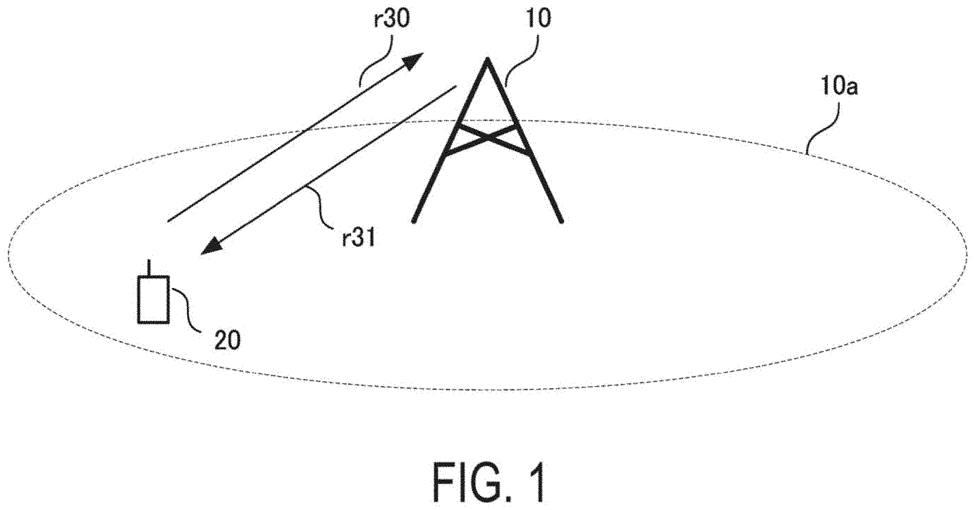

FIG. 1 is a diagram illustrating a configuration example of a communication system 1 according to the present embodiment. The communication system 1 according to the present embodiment includes a base station apparatus 10 and a terminal apparatus 20. Coverage 10a is a range (a communication area) in which the base station apparatus 10 can connect to (communicate with) the terminal apparatus 20 (coverage 10a is also referred to as a cell). Note that the base station apparatus 10 can accommodate a plurality of terminal apparatuses 20 in the coverage 10a.

In FIG. 1, an uplink radio communication r30 includes at least the following uplink physical channels. The uplink physical channels are used to transmit information output from a higher layer.
physical uplink control channel (PUCCH)
physical uplink shared channel (PUSCH)
physical random access channel (PRACH)

The PUCCH is a physical channel that is used to transmit Uplink Control Information (UCI). The uplink control information includes positive acknowledgement (ACK)/negative acknowledgement (HACK) in response to downlink data. Here, the downlink data indicates a Downlink transport block, a Medium Access Control Protocol Data Unit (MAC PDU), a Downlink-Shared Channel (DL-SCH), a Physical Downlink Shared Channel (PDSCH), and the like. The ACK/NACK is also referred to as a Hybrid Automatic Repeat request ACKnowledgement (HARQ-ACK), a HARQ feedback, a HARQ response, or a signal indicating HARQ control information or a delivery confirmation.

NR supports at least five formats, namely a PUCCH format 0, a PUCCH format 1, a PUCCH format 2, a PUCCH format 3, and a PUCCH format 4. The PUCCH format 0 and the PUCCH format 2 include one or two OFDM symbols, and the other PUCCHs include four to fourteen OFDM symbols. Also, the bandwidth of the PUCCH format 0 and the PUCCH format 1 includes twelve subcarriers. Moreover, in the PUCCH format 0, one bit (or two bits) of ACK/NACK is transmitted in resource elements of twelve subcarriers and one OFDM symbol (or two OFDM symbols).

The uplink control information includes a Scheduling Request (SR) used to request a PUSCH (Uplink-Shared Channel (UL-SCH)) resource for initial transmission. The scheduling request indicates that the UL-SCH resource for initial transmission is requested.

The uplink control information includes downlink Channel State Information (CSI). The downlink channel state information includes a Rank indicator (RI) indicating a preferable spatial multiplexing order (the number of layers), a Precoding Matrix Indicator (MI) indicating a preferable precoder, a Channel Quality Indicator (CQI) designating a preferable transmission rate, and the like. The PMI indicates a codebook determined by the terminal apparatus. The codebook is related to preceding of the physical downlink shared channel.

In the NR, higher layer parameter RI restriction can be configured. There are a plurality of configuration parameters for the RI restriction, and one of them is a type 1 single panel RI restriction and includes eight bits. The type I single panel RI restriction that is a bitmap parameter forms a bit sequence r₇, . . . , r₂, r₁. Here, r₇ is a Most Significant Bit (MSB), and r₀ is a Least Significant Bit (LSB). In a case that rᵢ is zero (i is 0, 1, . . . , 7), PMI and RI reporting corresponding to a precoder associated with an i+1 layers are not allowed. The RI restriction includes, in addition to the type 1 single panel RI restriction, type 1 multi panel RI restriction and the type 1 multi panel RI restriction includes four bits. The type 1 multi panel RI restriction, which is a bitmap parameter, forms a bit sequence r₄, r₃, r₂. Here, r₄ is the MSB, and r₀ is the LSB. In a case that r₁ is zero (i is 0, 1, 2, 3), PMI and RI reporting corresponding to a precoder associated with the i+1 layers are not allowed.

The CQI can use an index (CQI index) indicative of a preferable modulation scheme (for example, QPSK, 16 QAM, 64 QAM, 256 QAMAM, or the like), a coding rate, and frequency efficiency in a predetermined band. The terminal apparatus selects, from a CQI table, a CQI index considered to allow a transport block of the PDSCH to be received within a block error probability (BIER)=0.1. However, in a case that a predetermined CQI table is configured by higher layer signaling, a CQI index considered to allow reception within BLER=0.00001 is selected from the CQI table.

The PUSCH is a physical channel used to transmit uplink data (an Uplink Transport Block, an Uplink-Shared Channel (UL-SCH)), and CP-OFDM or DFT-S-OFDM is applied as a transmission scheme. The PUSCH may be used to transmit the HARQ-ACK in response to the downlink data and/or the channel state information along with the uplink data. The PUSCH may be used to transmit only the channel state information, The PUSCH may be used to transmit only the HARQ-ACK and the channel state information.

The PUSCH is used to transmit Radio Resource Control (RRC) signaling. The RRC signaling is also referred to as an RRC message/RRC layer information/an RRC layer signal/an RRC layer parameter/an RRC information element. The RRC signaling is information/signal processed in a radio resource control layer. The RRC signaling transmitted from the base station apparatus may be signaling common to a plurality of terminal apparatuses in a cell. The RRC signaling transmitted from the base station apparatus may be signaling dedicated to a certain terminal apparatus (also referred to as dedicated signaling). In other words, user equipment specific (user equipment unique) information is transmitted using the signaling dedicated to the certain terminal apparatus, The RRC message can include a UE Capability of the terminal apparatus. The UE Capability is information indicating a function supported by the terminal apparatus.

The PUSCH is used to transmit a Medium Access Control Element (MAC CE). The MAC CE is information/signal processed (transmitted) in a Medium Access Control layer. For example, a power headroom may be included in the MAC CE and may be reported via the PUSCH. In other words, a MAC CE field is used to indicate a level of the power headroom. The RRC signaling and/or the MAC CE is also referred to as a higher layer signal (higher layer signaling). The RRC signaling and/or the MAC CE are included in a transport block.

The PRACH is used to transmit a preamble used for random access, The PRACH is used to transmit a random access preamble. The PRACH is used to indicate an initial connection establishment procedure, a handover procedure, a connection re-establishment procedure, synchronization (timing adjustment) of uplink transmission, and a request for the PUSCH (UL-SCI) resource.

In the uplink radio communication, an Uplink Reference Signal (UL RS) is used as an uplink physical signal. The uplink reference signal includes a Demodulation Reference Signal (DMRS), a Sounding Reference Signal (SRS), a Phase Tracking Reference Signal (PTRS), and the like. The DMRS is associated with transmission of the physical uplink shared channel/physical uplink control channel. For example, the base station apparatus 10 uses the demodulation reference signal to perform channel estimation/channel compensation in a case of demodulating the physical uplink shared channel/the physical

The SRS is not associated with the transmission of the physical uplink shared channel/the physical uplink control channel. The base station apparatus 10 uses the SRS to measure an uplink channel state (CSI Measurement).

The PTRS is associated with transmission of the physical uplink shared channel/physical uplink control channel. The base station apparatus 10 uses the SRS for phase tracking.

In FIG. 1, at least the following downlink physical channels are used in radio communication of the downlink r31. The downlink physical channels are used to transmit information output from the higher layer.
physical broadcast channel (PBCH)
physical downlink control channel (PDCCH)
physical downlink shared channel (PDSCH)

The PBCH is used to broadcast a Master Information Block (MIB, a Broadcast Channel (BCH)) that is used commonly by the terminal apparatuses. The MIB is one of pieces of system information. For example, the MIB includes a downlink transmission bandwidth configuration and a System Frame number (SFN). The MIB may include information indicating at least some of a slot number, a subframe number, and a radio frame number in which the PBCH is transmitted.

The PDCCH is used to transmit downlink control information (DCI). For the downlink control information, a plurality of formats (also referred to as DCI formats) based on applications are defined. The DCI format may be defined based on the type and the number of bits of the DCI included in a single DCI format. Each format is used depending on the application. The downlink control information includes control information for downlink data transmission and control information for uplink data transmission. The DCI format for downlink data transmission is also referred to as downlink assignment (or downlink grant). The DCI format for uplink data transmission is also referred to as uplink grant (or uplink assignment).

A single downlink assignment is used for scheduling of a single PDSCH in a single serving cell. The downlink grant may be used for at least scheduling of the PDSCH within the same slot as the slot in which the downlink grant has been transmitted. The downlink assignment includes downlink control information, such as frequency domain resource allocation and a time domain resource allocation for the PDSCH, a Modulation and Coding Scheme (MCS) for the PDSCH, a NEW Data Indicator (NDI) for indicating initial transmission or retransmission, information for indicating the HARQ process number in the downlink, and a Redundancy version for indicating an amount of redundancy added to the codeword during error correction coding. The codeword is data after the error correcting coding. The downlink assignment may include a Transmission Power Control (TPC) command for the PUCCH and a TPC command for the PUSCH. The uplink grant may include a Repetition number for indicating the number of repetitive transmission operations of the PUSCH. Note that the DCI format for each downlink data transmission operation includes information (field) required for the application of the above-described information.

A single uplink grant is used to notify the terminal apparatus of scheduling of a single PUSCH in a single serving cell. The uplink grant includes uplink control information, such as information related to the resource block allocation for transmission of the PUSCH (resource block allocation and hopping resource allocation), time domain resource allocation, information related to the MCS of the PUSCH (MCS/Redundancy version), information related to a DMRS port, information related to retransmission of the PUSCH, a TPC command for the PUSCH, and a request for downlink Channel State Information (CSI) (CSI request). The uplink grant may include information for indicating the HARQ process number in the uplink, information for indicating a redundancy version, a Transmission Power Control (TPC) command for the PUCCH, and a TPC command for the PUSCH. Note that the DCI format for each uplink data transmission includes information (field) required for the application of the above-described information.

An OFDM symbol number (position) for transmitting a DMRS symbol is provided by a period of signaling between the first OFDM symbol in the slot and the last OFDM symbol of the PDSCH resource scheduled in the slot in a case that intra-frequency hopping is not applied and the PUSCH mapping type A is applied. In a case that the intra-frequency hopping is not applied, and the PUSCH mapping type B is applied, the OFDM symbol number is provided by a scheduled PUSCH resource period. In a case that the intra-frequency hopping is applied, the OFDM symbol number is provided by a period per hopping, In regard to the PUSCH mapping type A, a case that the higher layer parameter indicating the number of additional DMRSs is three is supported only in a case that the higher layer parameter indicating the position of the leading DMRS is two. Also, in regard to the PUSCH mapping type A, a four-symbol period is applicable only in a case that the higher layer parameter indicating the position of the leading DMRS is two.

The PDCCH is generated by adding a Cyclic Redundancy Check (CRC) to the downlink control information. In the PDCCH, CRC parity bits are scrambled with a predetermined identity (also referred to as an exclusive OR operation, or a mask). The parity bits are scrambled with a Cell-Radio Network Temporary identifier (C-RNTI), a Configured Scheduling (CS)-RNTI, a Temporary C-RNTI, a Paging (P)-RNTI, a System Information (SI)-RNTI or a Random Access (RA)-RNTI, a Semi-Persistent Channel State-Information (SP-CSI)-RNTI, or an MCS-C-RNTI. The C-RNTI and the CS-RNTI are identities for identifying a terminal apparatus within a cell. The Temporary C-RNTI is an identity for identifying the terminal apparatus that has transmitted a random access preamble during a contention based random access procedure. The C-RNTI and the Temporary C-RNTI are used to control PDSCH transmission in a single subframe or PUSCH transmission. The CS-RNTI is used to periodically allocate a resource for the PDSCH or the PUSCH. Here, the PDCCH (DCI format) scrambled by the CS-RNTI is used to activate or deactivate the CS type 2. On the other hand, in the CS type 1, control information (such as the MCS and radio resource allocation) included in the PDCCH scrambled by the CS-RNTI is included in a higher layer parameter related to the CS and activates (configures) the CS with the higher layer parameter. The P-RNTI is used to transmit a paging message (Paging Channel (PCH)). The SI-RNTI is used to transmit an SIB. The RA-RNTI is used to transmit a random access response (a message 2 in a random access procedure). The SP-CSI-RNTI is used for semi-static CSI reporting. The MCS-C-RNTI is used in a case that an MCS table with low spectral efficiency is selected.

The PDSCH is used to transmit the downlink data (the downlink transport block, DL-SCI). The PDSCH is used to transmit a system information message (also referred to as a System Information Block (SIB)). Some or all of the SIBS can be included in the RRC message.

The PDSCH is used to transmit the RRC signaling. The RRC signaling transmitted from the base station apparatus may be common to the plurality of terminal apparatuses in the cell (unique to the cell). That is, the information common to user equipments in the cell is transmitted using the RRC signaling unique to the cell. The RRC signaling transmitted from the base station apparatus may be a message dedicated to a certain terminal apparatus (also referred to as dedicated signaling). In other words, user equipment specific (user equipment unique) information is transmitted by using the message dedicated to the certain terminal apparatus.

The PDSCH is used to transmit the MAC CE. The RRC signaling and/or the MAC CE is also referred to as a higher layer signal (higher layer signaling). The PMCH is used to transmit multicast data (Multicast Channel (MCH)).

In the downlink radio communication in FIG. 1, a Synchronization signal (SS) and a Downlink Reference Signal (DL RS) are used as downlink physical signals. The downlink physical signals are not used to transmit information output from the higher layers, but are used by the physical layer.

The synchronization signal is used for the terminal apparatus to take synchronization of the downlink in the frequency domain and the time domain. The downlink reference signal is used for the terminal apparatus to perform the channel estimation/channel compensation on the downlink physical channel. For example, the downlink reference signal is used to demodulate the PBCH, the PDSCH, and the PDCCH. The downlink reference signal can be used by the terminal apparatus to measure the downlink channel state (CSI measurement).

The downlink physical channel and the downlink physical signal are also collectively referred to as a downlink signal. In addition, the uplink physical channel and the uplink physical signal are also collectively referred to as an uplink signal. In addition, the downlink physical channel and the uplink physical channel are also collectively referred to as a physical channel. In addition, the downlink physical signal and the uplink physical signal are also collectively referred to as a physical signal.

The BCH, the UL-SCH, and the DL-SCH are transport channels, Channels used in the MAC layer are referred to as transport channels. A unit of the transport channel used in the MAC layer is also referred to as a Transport Block (TB) or a MAC Protocol Data Unit (PDU). The transport block is a unit of data that the MAC layer delivers to the physical layer. In the physical layer, the transport block is mapped to a codeword, and coding processing and the like are performed for each codeword.

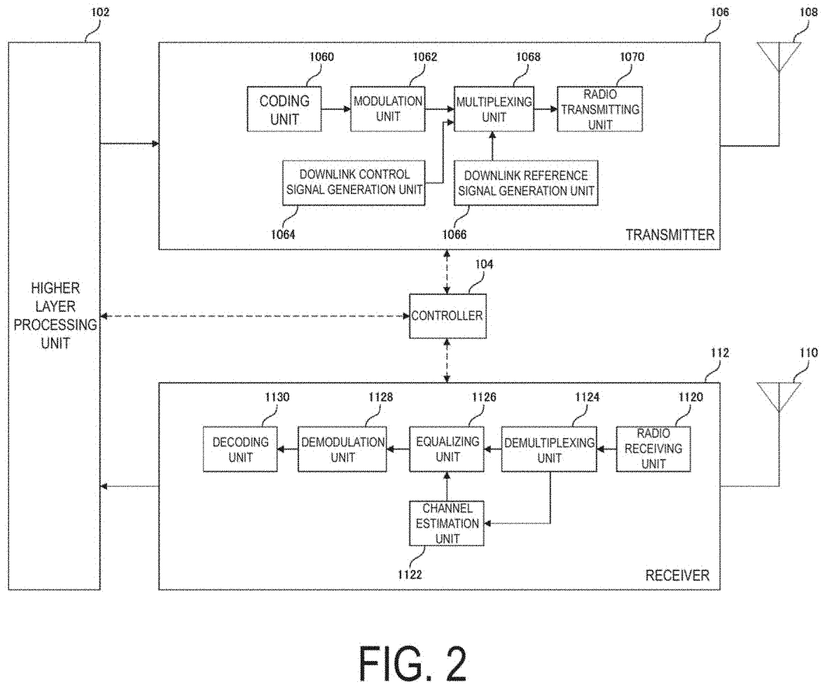

FIG. 2 is a schematic block diagram of a configuration of the base station apparatus 10 according to the present embodiment. The base station apparatus 10 includes a higher layer processing unit (higher layer processing step) 102, a controller (control step) 104, a transmitter (transmitting step) 106, a transmit antenna 108, a receive antenna 110, and a receiver (receiving step) 112. The transmitter 106 generates a physical downlink channel in accordance with a logical channel input from the higher layer processing unit 102. The transmitter 106 is configured to include a coding unit (coding step) 1060, a modulation unit (modulation step) 1062, a downlink control signal generation unit (downlink control signal generation step) 1064, a downlink reference signal generation unit (downlink reference signal generation step) 1066, a multiplexing unit (multiplexing step) 1068, and a radio transmitting unit (radio transmitting step) 1070. The receiver 112 detects (demodulates, decodes, or the like) the physical uplink channel and inputs the content to the higher layer processing unit 102. The receiver 112 is configured to include a radio receiving unit (radio receiving step) 1120, a channel estimation unit (channel estimation step) 1122, a demultiplexing unit (demultiplexing step) 1124, an equalizing unit (equalizing step) 1126, a demodulation unit (demodulation step) 1128, and a decoding unit (decoding step) 1130.

The higher layer processing unit 102 performs processing on a layer, such as a Medium Access Control (MAC) layer, a Packet Data Convergence Protocol (PDCP) layer, a Radio Link Control (RLC) layer, and a Radio Resource Control (RRC) layer, that is higher than the physical layer. The higher layer processing unit 102 generates information required to control the transmitter 106 and the receiver 112, and outputs the resultant information to the controller 104. The higher layer processing unit 102 outputs the downlink data (such as DL-SCH), the system information (MIB, SIB), and the like to the transmitter 106. Note that the DMRS structure information may be notified to the terminal apparatus by using the system information (MIB or SIB), instead of the notification by using the higher layer such as RRC.

The higher layer processing unit 102 generates, or acquires from a higher node, the system information (a part of the MIB or the SIB) to be broadcast. The higher layer processing unit 102 outputs the system information to be broadcast to the transmitter 106 as BCH/DL-SCH. The MIB is allocated to the PBCH in the transmitter 106. The SIB is allocated to the PDSCH in the transmitter 106. The higher layer processing unit 102 generates, or acquires from the higher node, the system information (SIB) specific to the terminal apparatus. The SIB is allocated to the PDSCH in the transmitter 106.

The higher layer processing unit 102 configures various RNTIs for each terminal apparatus. The RNTI is used for encryption (scrambling) of the PDCCH, the PDSCH, and the like. The higher layer processing unit 102 outputs the RNTI to the controller 104/the transmitter 106/the receiver 112.

In a case that the downlink data (transport block, DL-SCH) mapped to the PDSCH, the system information specific to the terminal apparatus (System Information Block (SIB)), the RRC message, the MAC CE, and the DMRS structure information are not notified by using the system information such as the SIB and the MIB, and the DCI, the higher layer processing unit 102 generates, or acquires from a higher node, the DMRS structure information or the like and then outputs the information generated or acquired to the transmitter 106. The higher layer processing unit 102 manages various kinds of configuration information of the terminal apparatus 20. Note that a part of the function of the radio resource control may be performed in the MAC layer or the physical layer.

The higher layer processing unit 102 receives information on the terminal apparatus, such as the function supported by the terminal apparatus (UE capability), from the terminal apparatus 20 (via the receiver 112). The terminal apparatus 20 transmits its own function to the base station apparatus 10 by a higher layer signaling (RRC signaling). The information on the terminal apparatus includes information for indicating whether the terminal apparatus supports a predetermined function or information for indicating that the terminal apparatus has completed implementation and testing of the predetermined function. The information for indicating whether the predetermined function is supported includes information for indicating whether the implementation and testing of the predetermined function have been completed.

In a case that the terminal apparatus supports the predetermined function, the terminal apparatus transmits information (parameter) for indicating whether the predetermined function is supported. In a case that the terminal apparatus does not support the predetermined function, the terminal apparatus may be configured not to transmit information (parameter) for indicating whether the predetermined function is supported. In other words, whether the predetermined function is supported is notified by whether information (parameter) for indicating whether the predetermined function is supported is transmitted. Note that the information (parameter) for indicating whether the predetermined function is supported may be notified by using one bit of 1 or 0.

The higher layer processing unit 102 acquires the DL-SCH from the decoded uplink data (including the CRC) from the receiver 112. The higher layer processing unit 102 performs error detection on the uplink data transmitted by the terminal apparatus, For example, the error detection is performed in the MAC layer.

The controller 104 controls the transmitter 106 and the receiver 112 based on the various kinds of configuration information input from the higher layer processing unit 102/receiver 112. The controller 104 generates the downlink control information (DCI) based on the configuration information input from the higher layer processing unit 102/receiver 112, and outputs the generated downlink control information to the transmitter 106. For example, the controller 104 configures, in consideration of the configuration information on the DMRS input from the higher layer processing unit 102/receiver 112 (whether the configuration is the DMRS structure 1 or the DMRS structure 2), the frequency allocation of the DMRS (an even subcarrier or an odd subcarrier in the case of the DMRS structure 1, and any of the zeroth to the second sets in the case of the DMRS structure 2), and generates the DCI.

The controller 104 determines the MCS of the PUSCH in consideration of channel quality information (CSI Measurement result) measured by the channel estimation unit 1122. The controller 104 determines an MCS index corresponding to the MCS of the PUSCH. The controller 104 includes, in the uplink grant, the MCS index determined.

The transmitter 106 generates the PBCH, the PDCCH, the PDSCH, the downlink reference signal, and the like in accordance with the signal input from the higher layer processing unit 102/controller 104. The coding unit 1060 performs coding (including repetition) using a block code, a convolutional code, a turbo code, a polar coding, an LDPC code, or the like on the BCH, the DL-SCH, and the like input from the higher layer processing unit 102 by using a predetermined coding scheme/a coding scheme determined by the higher layer processing unit 102. The coding unit 1060 performs puncturing on the coded bits based on the coding rate input from the controller 104. The modulation unit 1062 performs data modulation on the coded bits input from the coding unit 1060 by using a modulation scheme (modulation order) predefined, such as the BPSK, the QPSK, the 16 QAM, the 64 QAM, or the 256 QAM/a modulation scheme (modulation order) input from the controller 104. The modulation order is based on the MCS index selected by the controller 104.

The downlink control signal generation unit 1064 adds the CRC to the DCI input from the controller 104. The downlink control signal generation unit 1064 encrypts (scrambles) the CRC by using the RNTI. Furthermore, the downlink control signal generation unit 1064 performs QPSK modulation on the DCI to which the CRC is added, and generates the PDCCH. The downlink reference signal generation unit 1066 generates a sequence known to the terminal apparatus as the downlink reference signal. The known sequence is determined by a predetermined rule based on a physical cell identity for identifying the base station apparatus 10 and the like.

The multiplexing unit 1068 multiplexes the PDCCHs/downlink reference signals/modulation symbols of the respective channels input from the modulation unit 1062. In other words, the multiplexing unit 1068 maps the PDCCHs/downlink reference signals, modulation symbols of the respective channels to the resource elements. The resource elements to which the mapping is performed are controlled by downlink scheduling input from the controller 104. The resource element is the minimum unit of a physical resource including one OFDM symbol and one subcarrier. Note that, in a case of performing MIMO transmission, the transmitter 106 includes as many the coding units 1060 and the modulation units 1062 as the number of layers. In this case, the higher layer processing unit 102 configures the MCS for each transport block in the corresponding

The radio transmitting unit 1070 performs Inverse Fast Fourier Transform (IFFT) on the multiplexed modulation symbol and the like to generate OFDM symbols. The radio transmitting unit 1070 adds cyclic prefixes (CPs) to the OFDM symbols to generate a baseband digital signal. Furthermore, the radio transmitting unit 1070 converts the digital signal into an analog signal, removes unnecessary frequency components from the analog signal through filtering, performs up-conversion to a signal of a carrier frequency, performs power amplification, and outputs the resultant signal to the transmit antenna 108 for transmission.

In accordance with an indication from the controller 104, the receiver 112 detects (demultiplexes, demodulates, and decodes) the reception signal received from the terminal apparatus 20 through the receive antenna 110, and inputs the decoded data to the higher layer processing unit 102/controller 104, The radio receiving unit 1120 converts the uplink signal received through the receive antenna 110 into a baseband signal by down-conversion, removes unnecessary frequency components from the baseband signal, controls an amplification level so that a signal level is suitably maintained, performs orthogonal demodulation based on an in-phase component and an orthogonal component of the received signal, and converts the resulting orthogonally-demodulated analog signal into a digital signal. The radio receiving unit 1120 removes a part corresponding to the CP from the converted digital signal. The radio receiving unit 1120 performs Fast Fourier Transform (FFT) on the signal from which the CPs have been removed, and extracts a signal in the frequency domain. The signal in the frequency domain is output to the demultiplexing unit 1124.

The demultiplexing unit 1124 demultiplexes the signals input from the radio receiving unit 1120 into signals, such as the PUSCH, the PUCCH, and the uplink reference signal, based on uplink scheduling information (such as uplink data channel allocation information) input from the controller 104. The uplink reference signal resulting from the demultiplexing is input to the channel estimation unit 1122. The PUSCH and PUCCH resulting from the demultiplexing are output to the equalizing unit 1126.

The channel estimation unit 1122 uses the uplink reference signal to estimate a frequency response (or a delay profile). The result of the frequency response that is channel estimated for demodulation is input to the equalizing unit 1126, The channel estimation unit 1122 measures the uplink channel state (measures a Reference Signal Received Power (RSRP), a Reference Signal Received Quality (RSRQ), and a Received Signal Strength Indicator (RSSI)) by using the uplink reference signal. The measurement of the uplink channel state is used to determine the MCS for the PUSCH and the like.

The equalizing unit 1126 performs processing to compensate for an influence in a channel based on the frequency response input from the channel estimation unit 1122. As a method for the compensation, any existing channel compensation, such as a method of multiplying an MMSE weight or an MRC weight or a method of applying an MLD, is applicable. The demodulation unit 1128 performs demodulation processing based on the information on a predetermined modulation scheme/the information on a modulation scheme indicated by the controller 104.

The decoding unit 1130 performs decoding processing on the output signal from the demodulation unit based on the information on a predetermined coding rate/the information on a coding rate indicated by the controller 104. The decoding unit 1130 inputs the decoded data (such as the UL-SCH) to the higher layer processing unit 102.

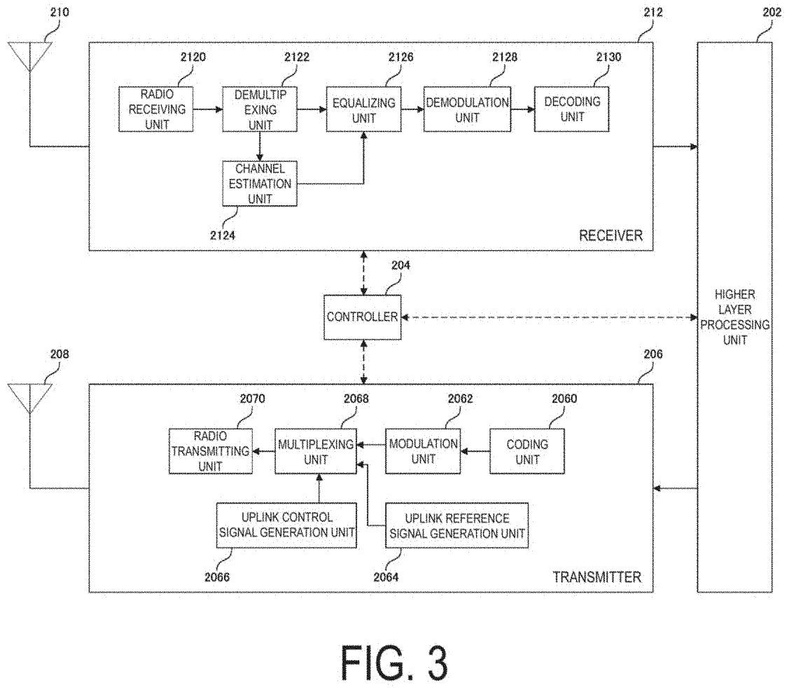

FIG. 3 is a schematic block diagram illustrating a configuration of the terminal. apparatus 20 according to the present embodiment. The terminal apparatus 20 is configured to include a higher layer processing unit (higher layer processing step) 202, a controller (control step) 204, a transmitter (transmitting step) 206, a transmit antenna 208, a receive antenna 210, and a receiver (receiving step) 212.

The higher layer processing unit 202 performs processing of the medium access control (MAC) layer, the packet data convergence protocol (PDCP) layer, the radio link control (RLC) layer, and the radio resource control (RRC) layer. The higher layer processing unit 202 manages various kinds of configuration information of the terminal apparatus itself. The higher layer processing unit 202 notifies the base station apparatus 10 of information for indicating terminal apparatus functions supported by the terminal apparatus itself (UE Capability) via the transmitter 206. The higher layer processing unit 202 notifies the base station apparatus of the UP Capability by RRC signaling.

The higher layer processing unit 202 acquires the decoded data, such as the DL-SCH and the BCH, from the receiver 212. The higher layer processing unit 202 generates the HARQ-ACK from a result of the error detection of the DL-SCH. The higher layer processing unit 202 generates the SR. The higher layer processing unit 202 generates the UCI including the HARQ-ACK/SR/CSI (including the CQI report). In a case that the DMRS structure information is notified by the higher layer, the higher layer processing unit 202 inputs the information on the DMRS structure to the controller 204. The higher layer processing unit 202 inputs the UCI and the UL-SCH to the transmitter 206. Note that some functions of the higher layer processing unit 202 may be included in the controller 204.

The controller 204 interprets the downlink control information (DCI) received via the receiver 212. The controller 204 controls the transmitter 206 in accordance with PUSCH scheduling/MCS index/Transmission Power Control (TPC), and the like acquired from the DCI for uplink transmission. The controller 204 controls the receiver 212 in accordance with the PUSCH scheduling/the MCS index and the like acquired front the DCI for downlink transmission. Furthermore, the controller 204 identifies the frequency allocation of the DMRS according to the information related to the frequency allocation (port number) of the DMRS included in the DCI for downlink transmission and the DMRS structure information input from the higher layer processing unit 202.

The transmitter 206 is configured to include a coding unit (coding step) 2060, a modulation unit (modulation step) 2062, an uplink reference signal generation unit (uplink reference signal generation step) 2064, an uplink control signal generation unit (uplink control signal generation step) 2066, a multiplexing unit (multiplexing step) 2068, and a radio transmitting unit (radio transmitting step) 2070.

In accordance with the control by the controller 204 (in accordance with the coding rate calculated based on the MCS index), the coding unit 2060 codes the uplink data (UL-SCH) input from the higher layer processing unit 202 by convolutional coding, block coding, turbo coding, or the like.

The modulation unit 2062 modulates the coded bits input from the coding unit 2060 (generates modulation symbols for the PUSCH) with a modulation scheme indicated from the controller 204, such as BPSK, QPSK, 16 QAM, 64 QAM, and 256 QAM/a modulation scheme predetermined for each channel.

The uplink reference signal generation unit 2064 generates a sequence determined from a predetermined rule (formula), based on a physical cell identity (PCI), which is also referred to as a cell ID, or the like, for identifying the base station apparatus 10, a bandwidth in which the uplink reference signals are mapped, a cyclic shift, parameter values to generate the DMRS sequence, further the frequency allocation, and the like, in accordance with an indication by the controller 204.

In accordance with the indication from the controller 204, the uplink control signal generation unit 2066 codes the UCI, performs the BPSK/QPSK modulation, and generates modulation symbols for the PUCCH.

Here, the frequency hopping in Rel.15 will be described. The terminal apparatus is configured by a higher layer parameter related to frequency hopping that is provided in RRC signaling for PUSCH transmission or RRC signaling for configured grant scheduling in regard to the frequency hopping of scheduled or configured PUSCH transmission. The following two frequency hopping modes can be configured. One is intra-slot frequency hopping and is applicable to single-slot or multi-slot PUSCH transmission. The other one is inter-slot frequency hopping and is applicable to multi-slot PUSCH transmission. In a case of a resource allocation type 1, that is, in a case of a type of allocation using continuous RBs in the frequency domain, the terminal apparatus may perform frequency hopping of the PUSCH in a case that a frequency hopping field in a detected corresponding DCI format or a random access response uplink grant is set to 1, or in a case that a higher layer parameter related to a frequency hopping offset is provided in regard to type 1 PUSCH transmission using a configured grant, regardless of whether transform preceding is valid for the PUSCH transmission. Otherwise, the PUSCH frequency hopping is not applied.

In regard to the PUSCH scheduled by the DCI format 0_0 or 0_1, or the PUSCH based on the type 2 configured UL grant and resource allocation type 1, the frequency offset is configured by a higher layer parameter for a frequency hopping offset list in the RRC signaling for the PUSCH transmission. In a case that the size of the active BWP is less than 50 RBs, one of two offsets configured by the higher layer is indicated in the UL grant. In a case that the size of the active BWP is equal to or greater than 50 RBs, one of four offsets configured by the higher layer is indicated in the UL grant.

In regard to the PUSCH based on the type 1 configured UL grant, the frequency offset is provided by a higher layer parameter related to a frequency hopping offset in the RRC signaling for configured grant scheduling. The start RB in the first hop is provided as RBₛₜₐᵣₜ, and the start RB in the second hop is provided as (RBₛₜₐᵣₜ+RB_{offset}) mod N_{BWP}. Here, RBₛₜₐᵣₜ is a start RB in the UL BWP calculated from resource block allocation information of the resource allocation type 1, and RB_{offset} is a frequency offset of the RB between two frequency hops. Moreover, N_{BWP} is the number of RBs configuring the BWP and represents the number of RBs in the BWP.

In a case that the intra-slot frequency hopping is applied, the number of symbols for the first hop is provided as a maximum integer within N/2, and the number of symbols for the second hop is provided as a value obtained by subtracting the maximum integer within N/2 from N. Here, N is the length of the PUSCH transmission with the OFDM symbols in one slot.

In a case of the inter-slot frequency hopping, the start RB in the slot n is provided as follows. The start RB is RBₛₜₐᵣₜ in a case that n mod 2=0 is satisfied, that is, the slot number is an even number, and the start RB is (RBₛₜₐᵣₜ+RB_{offset}) mod N_{BWP} in a case that n mod 2=1 is satisfied, that is, the slot number is an odd number. Here, n is a current slot number in one radio frame and multi-slot PUSCH transmission is applied, and RBₛₜₐᵣₜ is a start RB in the UL MVP calculated from the resource block allocation information of the resource allocation type 1, and RB_{offset} is a frequency offset of the RB between two frequency hops.

The multiplexing unit 2068 multiplexes, for each transmit antenna port (DMRS port), a modulation symbol for the PUSCH, a modulation symbol for the PUCCH, and an uplink reference signal in accordance with uplink scheduling information (a transmission interval in Configured Scheduling (CS) for the uplink included in the RRC message and frequency domain and time domain resource allocation and the like included in the DCI) from the controller 204 (in other words, each signal is mapped to a resource element).

Here, configured scheduling (CS or configured grant scheduling) will be described. There are two types of transmission without dynamic grant. One is a configured grant type 1 that is provided by the RRC and is stored as a configured grant, and the other one is a configured grant type 2 that is provided by the PDCCH and is stored and cleared as a configured grant based on L1 signaling indicating configured grant activation or configured grant deactivation. The types 1 and 2 are configured by the RRC for each serving cell and for each BWP. The plurality of configurations can become active at the same time only in different serving cells. In regard to the type 2, activation and deactivation are independent between serving cells. In regard to the same serving cell, an MAC entity is configured by either the type 1 or the type 2. In a case that the type 1 is configured, the RRC configures the following parameters.
cs-RNTI: CS-RNTI for retransmission
periodicity: a periodicity of the configured grant type 1
timeDomainOffset: an offset of a resource related to SFN=0 in the time domain
timeDomainAllocation: allocation of a configured grant in the time domain including a parameter startSymbolAndLength
nrofHARQ-Processes: the number of HARQ processes

In addition, in a case that the type 2 is configured, the RRC configures the following parameters.
cs-RNTI: CS-RNTI for activation, deactivation, and retransmission
periodicity: a periodicity of the configured grant type 2
nrofHARQ-Processes: the number of HARQ processes

In other words, ConfiguredGrantConfig is used to configure uplink transmission without dynamic grant in accordance with the two schemes, The actual uplink grant is configured via the RRC for the Configured Grant type 1 and is provided via the PDCCH processed by the CS-RNTI for the Configured Grant Type 2.

A parameter repK configured by the higher layer defines the number of repetitions to be applied to the transmitted transport blocks. repK-RV indicates a redundancy version pattern to be applied to the repetition. In regard to the n-th transmission opportunity among K repetitions, transmission associated with the (mod (n−1, 4)+1)-th value in a configured RV sequence (redundancy version pattern) is performed. In addition, the first transmission of one transport block is initiated in the first transmission opportunity in the K repetitions in a case that the configured RV sequence is {0, 2, 3, 1}. In a case that the configured RV sequence is {0, 3, 0, 3}, the first transmission is initiated in any of the transmission opportunities in the K repetitions associated with RV=0. In a case that the configured RV sequence is {0, 0, 0, 0}, the first transmission is initiated in any of the transmission opportunities in the K repetitions except for the last transmission opportunity in a case of K=8. In regard to any of the RV sequences, the repetition is terminated in a case that any of a timing after transmission is repeated K times, or a timing of the last transmission opportunity in the K repetitions in the periodicity P, or a timing of receiving an uplink grant for scheduling the same transport block in the same periodicity P is reached for the first time. The terminal apparatus does not expect to be configured a time period related to transmission repeated K times, which is longer than the time period calculated by the periodicity P. In a case that the terminal apparatus is configured as repK>1 for both the PUSCH transmission of the type 1 and the PUSCH transmission of the type 2 performed by the configured grant, the terminal apparatus repeats the transport block over repK continuous slots. At this time, the terminal apparatus applies the same symbol allocation in each slot. In a case that the procedure of the terminal apparatus related to decision of a slot structure determines (decides) a symbol of an allocated slot as a downlink symbol, the transmission in the slot is omitted in regard to PUSCH transmission in a plurality of slots. In a case that the repK is configured, any of once, twice, four times, and eight times can be configured as a value. However, in a case that the RRC parameter itself is not present, the transmission is performed with the number of repetitions being one. In addition, any of {0, 2, 3, 1}, {0, 3, 0, 3}, and {0, 0, 0, 0} can be configured as the repK-RV. Note that, although signals of different redundancy versions generated from the same transport block are signals including the same transport block (information bit sequence), at least parts of the including coded bits are different.

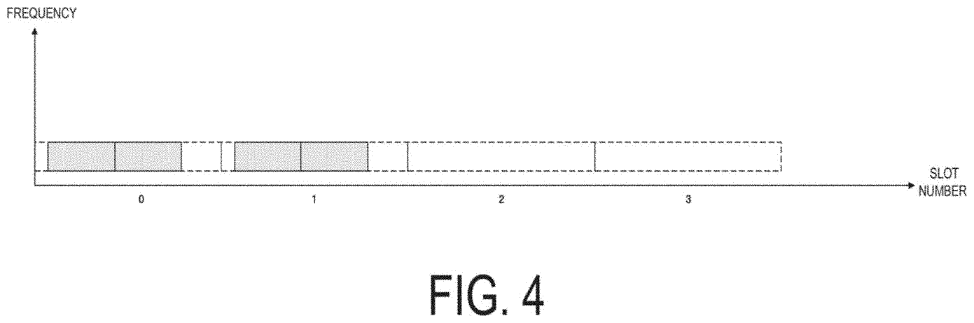

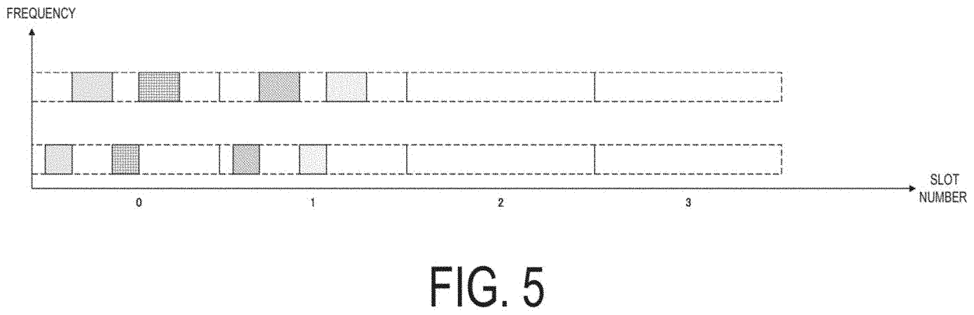

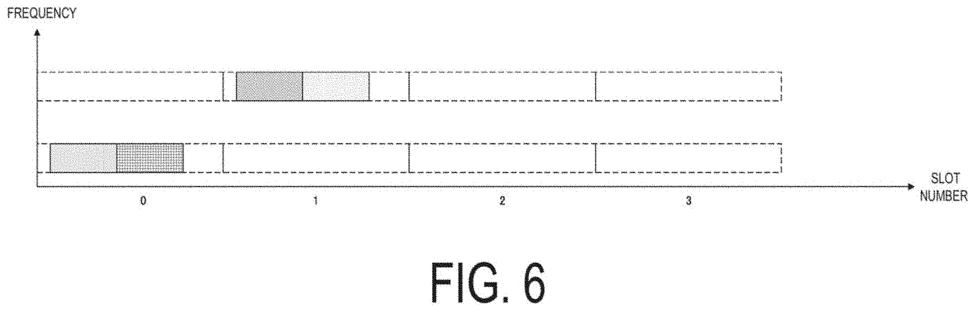

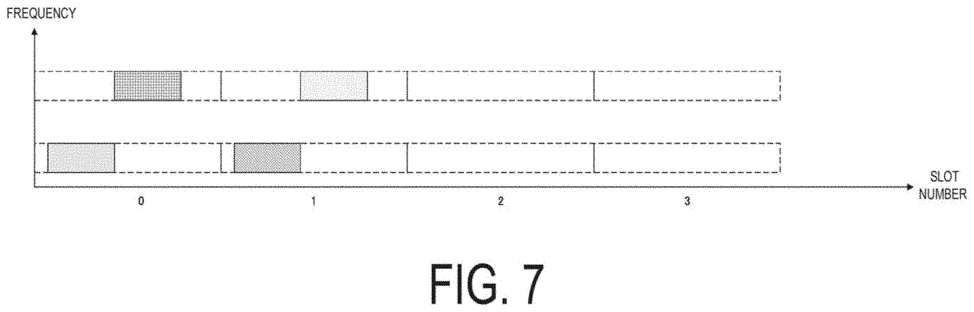

Although, in Rel. 15, allocation of one data signal (PUSCH) in one slot is specified, and transmission repeated over a plurality of slots is specified in repeated transmission, PUSCH transmission repeated a plurality of times in one slot is examined in Rel. 16. In a case that the RV sequence is {0, 0, 0, 0}, it is possible to configure a transmission start opportunities a plurality of times in one slot. For example, the dotted line in FIG. 4 represents one slot, and a situation in which transmission is repeated twice in one slot and transmission is repeated a total of four times using two slots will be considered. Here, it is assumed that RRC signaling related to an application of repetition in one slot has been configured in a case that the number of repetitions in one slot is achieved. The RRC signaling may be signaling indicating the number of repetitions in one slot, the number of OFDM symbols used for one PUSCH in one slot, the number of slots to be split, or the like instead of the simple signaling related to the application. In a case that intra-slot hopping is configured, the number of symbols for the first hop is provided as the maximum integer within N/2, and the number of symbols for the second hop is provided as a value obtained by subtracting the maximum integer within N/2 from N. Here, N may be the length of PUSCH transmission per one repetition in the OFDM symbols in one slot or may be the length of PUSCH transmission that takes all the repetitions in the OFDM symbols in one slot into consideration. In a case that N is the length of the PUSCH transmission per one repetition, the slot structure as in FIG. 5 is used. At this time, because one PUSCH (transport block) is transmitted using a plurality RBs that are not continuous, it is possible to obtain a frequency diversity effect for each repeated transmission (PUSCH transmission). On the other hand, in a case that N is the length of the PUSCH transmission that takes all the repetitions in the OFDM symbols in one slot into consideration, the slot structure as in FIG. 6 is used. At this time, the one PUSCH (transport block) is transmitted without an application of hopping. In a case that inter-slot hopping is configured, and the RRC signaling related to application of repetition in one slot is not configured, the start resource block in the slot n is provided by the inter-slot frequency hopping similarly to the frequency hopping in Rel. 15. Here, n is a current slot number in one radio frame and is limited to a case that multi-slot PUSCH transmission is performed. RBₛₜₐᵣₜ is a start RB in an uplink Band Width Part (BAT) and is calculated from resource block allocation information of the resource allocation type 1, and RB_{offset} is a frequency offset of the RB between two frequency hops. On the other hand, in a case that inter-slot hopping is configured, and the RRC signaling related to the application of repetition in one slot is configured, the start resource block in the repetition k is provided as follows. The start RB is RBₛₜₐᵣₜ in a case that k mod 2=0 is satisfied, that is, in a case that the slot number is an even number, and the start RB is (RBₛₜₐᵣₜ+RB_{offset}) mod N_{BWP} in a case that k mod 2=1 is satisfied, that is, in a case that the slot number is an odd number. Here, k is the number of repetitions in the repK which is the number of repeated transmissions, and is specified by the RRC signaling or the DCI. In this case, hopping is applied as illustrated in FIG. 7. In other words, frequency hopping is not performed between slots depending on configurations of other RRC signaling regardless of the inter-slot frequency hopping being configured. This is because, in a case that the frequency hopping is performed between slots regardless of transmission being repeated a plurality of times in a slot as in FIG. 6, transmission is continuously performed using the same RB in a plurality of repetitions, and it is thus not possible to obtain a frequency diversity effect in the continuously repeated transmission. In an aspect of the present invention, in order to avoid this situation, transmission is performed by providing an offset to the RB of the PUSCH transmission every time repetition is performed regardless of the inter-slot frequency hopping having been configured. In this manner, because transmission is not continuously performed using the same RB in transmission repeated a plurality of times, it is possible to significantly improve a transmission performance in a case that repeated transmission is performed in a slot.

Note that although the number of times the transmission is repeated is assumed to be k in the above description, the number may be the number of times transmission is regarded as having been performed in the system instead of the number of times the transmission has actually been performed. In a case that transmission repeated four times is accepted, and transmission of the first two times has not been performed by the terminal apparatus for some reason, for example, the number k of times the transmission is repeated may start from three. (In a case that the number of times transmission is performed is counted from zero instead of one, k is two instead of three.) It is thus possible to share the frequency hopping pattern between the base station apparatus and the terminal apparatus even in a case that the transmission is skipped.

The hopping in a case that repeated transmission is performed in a slot may not necessarily be defined as described above. For example, the hopping may be defined not only by the current number of repetitions but also by the current number of repetitions and the current slot number in one radio frame.

Although, in regard to the RRC parameter related to the frequency hopping, the inter-slot frequency hopping or the intra-slot frequency hopping is assumed to be configured in the above description, it is not limited thereto, and a third parameter may be configured. In other words, a parameter indicating hopping between repeated transmissions (mini-slots) may be configured.

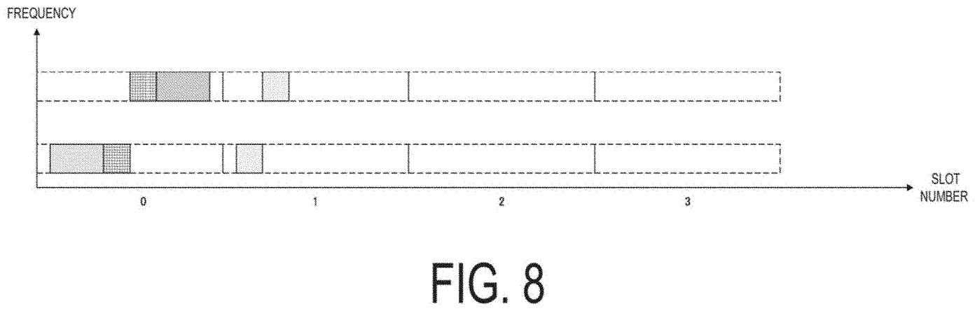

Also, in a case that the number of repetitions in one slot is neither one nor an even number, there is a probability that the intra-slot hopping is applied only to a part of the PUSCH as in FIG. 8. In order to avoid this situation, the base station may limit the number of times the transmission is repeated in one slot to one or to an even number. It is thus possible to prevent the intra-slot frequency hopping from being applied only to a specific PUSCH (repeated transmission). Alternatively, the number of OFDM symbols configuring a repetition unit may be limited in a case that the transmission is repeated in one slot. This is achieved by limiting the RRC parameter.

The radio transmitting unit 2070 performs Inverse Fast Fourier Transform (IFFT) on the multiplexed signals to generate OFDM symbols. The radio transmitting unit 2070 adds CPs to the OFDM symbols to generate a baseband digital signal. Furthermore, the radio transmitting unit 2070 converts the baseband digital signal into an analog signal, removes unnecessary frequency components from the analog signal, converts the signal into a signal of a carrier frequency by up-conversion, performs power amplification, and transmits the resultant signal to the base station apparatus 10 via the transmit antenna 208.

The receiver 212 is configured to includes a radio receiving unit (radio receiving step) 2120, a demultiplexing unit (demultiplexing step) 2122, a channel estimation unit (channel estimation step) 2144, an equalizing unit (equalizing step) 2126, a demodulation unit (demodulation step) 2128, and a decoding unit (decoding step) 2130.

The radio receiving unit 2120 converts the downlink signal received through the receive antenna 210 into a baseband signal by down-conversion, removes unnecessary frequency components from the baseband signal, controls an amplification level so that a signal level is suitably maintained, performs orthogonal demodulation based on an in-phase component and an orthogonal component of the received signal, and converts the resulting orthogonally-demodulated analog signal into a digital signal. The radio receiving unit 2120 removes a part corresponding to the CP from the digital signal resulting from the conversion, performs the FFT on the signal from which the CP has been removed, and extracts a signal in the frequency domain.

The demultiplexing unit 2122 demultiplexes the extracted signal in the frequency domain into the downlink reference signal, the PDCCH, the PDSCH, and the PBCH. A channel estimation unit 2124 uses the downlink reference signal (such as the DM-RS) to estimate a frequency response (or delay profile). The result of the frequency response that is channel estimated for demodulation is input to the equalizing unit 1126. The channel estimation unit 2124 measures the uplink channel state (measures a Reference Signal Received Power (RSRP), a Reference Signal Received Quality (RSRQ), a Received Signal Strength Indicator (RSSI), and a Signal to Interference plus Noise power Ratio (SINR)) by using the downlink reference signal (such as the CSI-RS). The measurement of the downlink channel state is used to determine the MCS for the PUSCH and the like. The measurement result of the downlink channel state is used to determine the CQI index and the like.

The equalizing unit 2126 generates an equalization weight based on an MMSE criterion using the frequency response input from the channel estimation unit 2124. The equalizing unit 2126 multiplies the input signal (the PUCCH, the PDSCH, the PBCH, and the like) from the demultiplexing unit 2122 by the equalization weight. The demodulation unit 2128 performs demodulation processing based on information of the predetermined modulation order/information of the modulation order indicated by the controller 204.

The decoding unit 2130 performs decoding processing on the output signal from the demodulation unit 2128 based on information of the predetermined coding rate/information of the coding rate indicated by the controller 204. The decoding unit 2130 inputs the decoded data (such as the DL-SCH) to the higher layer processing unit 202.

A program running on an apparatus according to an aspect of the present invention may serve as a program that controls a Central Processing Unit (CPU) and the like to cause a computer to operate in such a manner as to implement the functions of the above-described embodiments according to the aspect of the present invention. Programs or the information handled by the programs are temporarily loaded into a volatile memory such as a Random Access Memory (RAM) while being processed, or stored in a non-volatile memory such as a flash memory, or a Hard Disk Drive (HDD), and then read, modified, and written by the CPU, as necessary.

Note that the apparatuses in the above-described embodiments may be partially implemented by a computer. In that case, a program for implementing the functions of the embodiments may be recorded on a computer readable recording medium. It may be implemented by causing a computer system to read and execute the program recorded on this recording medium. It is assumed that the “computer system” refers to a computer system built into the apparatuses, and the computer system includes an operating system and hardware components such as a peripheral device. Furthermore, the “computer readable recording medium” may be any of a semiconductor recording medium, an optical recording medium, a magnetic recording medium, and the like.

Moreover, the “computer readable recording medium” may include a medium that dynamically retains a program for a short period of time, such as a communication wire that is used for transmission of the program over a network such as the Internet or over a communication line such as a telephone line, and may also include a medium that retains a program for a certain period of time, such as a volatile memory within the computer system for functioning as a server or a client in a case that the program is transmitted via the communication wire. Furthermore, the above-described program may be one for implementing part of the above-described functions, and also may be one capable of implementing the above-described functions in combination with a program already recorded in the computer system.

Furthermore, each functional block or various characteristics of the apparatuses used in the above-described embodiments may be implemented or performed with an electric circuit, that is, typically an integrated circuit or a plurality of integrated circuits. An electric circuit designed to perform the functions described in the present specification may include a general purpose processor, a digital signal processor (DSP), an application specific integrated circuit (ASIC), a field programmable gate array (FPGA), or other programmable logic devices, discrete gates or transistor logic, discrete hardware components, or a combination thereof. The general purpose processor may be a microprocessor or may be a processor, a controller, a micro-controller, or a state machine of known type, instead. The above-mentioned electric circuit may include a digital circuit, or may include an analog circuit. Furthermore, in a case that with advances in semiconductor technology, a circuit integration technology appears that replaces the present integrated circuits, it is also possible to use an integrated circuit based on the technology.

Note that the invention of the present application is not limited to the above-described embodiments. Although apparatuses have been described as an example in the embodiment, the invention of the present application is not limited to these apparatuses, and is applicable to a stationary type or a non-movable type electronic apparatus installed indoors or outdoors such as a terminal apparatus or a communication apparatus, for example, an AV device, a kitchen device, a cleaning or washing machine, an air-conditioning device, office equipment, a vending machine, and other household appliances.

Although the embodiments of the present invention have been described in detail above referring to the drawings, the specific configuration is not limited to the embodiments and includes, for example, design changes within the scope not depart from the gist of the present invention, Furthermore, various modifications are possible within the scope of claims, and embodiments that are made by suitably combining technical means disclosed according to the different embodiments are also included in the technical scope of the present invention. Furthermore, a configuration in which elements described in the respective embodiments and having mutually the same effects, are substituted for one another is also included.

### INDUSTRIAL APPLICABILITY

The present invention can be preferably used in a base station apparatus, a terminal apparatus, and a communication method.

1. A terminal apparatus for communicating with a base station apparatus, the terminal apparatus comprising:
a higher layer processing unit configured to configure a higher layer parameter related to frequency hopping and a higher layer parameter related to transmission of a plurality of transport blocks in a single slot; and
a transmitter configured to perform transmission based on configurations configured by the higher layer processing unit,
wherein in a case that a configuration related to inter-slot frequency hopping is configured as the higher layer parameter related to the frequency hopping, and the higher layer parameter related to the transmission of the plurality of transport blocks in the single slot is configured,
the transmitter applies the frequency hopping based on the current number of transmissions of transport blocks of the plurality of transport blocks.

2. The terminal apparatus according to claim 1, wherein
the plurality of transport blocks are generated from an identical information bit sequence with a different redundancy version.

3. The terminal apparatus according to claim 1, wherein
the transmitter applies the frequency hopping based on the current number of transmissions of the transport blocks and a current slot number in a radio frame.

4. A base station apparatus for communicating with a terminal apparatus, the base station apparatus comprising:
a higher layer processing unit configured to configure a higher layer parameter related to frequency hopping and a higher layer parameter related to transmission of a plurality of transport blocks in a single slot; and
a receiver configured to receive a signal transmitted by the terminal apparatus based on configurations configured by the higher layer processing unit,
wherein in a case that a configuration related to inter-slot frequency hopping is configured as the higher layer parameter related to the frequency hopping, and the higher layer parameter related to the transmission of the plurality of transport blocks in the single slot is configured,
the receiver performs reception assuming that the frequency hopping is applied based on the current number of transmissions of transport blocks of the plurality of transport blocks in the terminal apparatus,

5. The base station apparatus according to claim 4, wherein
the plurality of transport blocks are generated from an identical information bit sequence with a different redundancy version.

6. The base station apparatus according to claim 4, wherein
the receiver applies the frequency hopping based on the current number of transmissions of the transport blocks and a current slot number in a radio frame.
